(19) United States
(12) Patent Application Publication
(10) Pub. No.: US 2016/0218645 A1
(43) Pub. Date: Jul. 28, 2016

(54) Detection device for brushless AC/DC electric motor

(71) Applicant: MING CHANG LEE, Taipei City (TW)

(72) Inventor: MING CHANG LEE, Taipei City (TW)

(21) Appl. No.: 14/603,432

(22) Filed: Jan. 23, 2015

(51) Int. Cl. H02P 6/14; H02P 29/00

(52) U.S. Cl. CPC H02P 6/14; H02P 29/00

(57) ABSTRACT

A detection device for a brushless AC/DC electric motor is employed to detect signals and is electrically connected with the brushless AC/DC electric motor, wherein the brushless AC/DC electric motor includes a power wire and a carbon brush and is driven by an AC/DC power source. The detection device contains an input end and an output end, and the detection device also contains a signal capturing unit, a signal amplifier, a signal filter, a signal comparator, and a phase-locked loop unit which are electrically connected between the input end and the output end. Accordingly, abnormalities, rotation speed, rotation angle, displacement, overloading and operating data of the electric motor are detected, controlled, and fed back by the detection device.

### FIELD OF THE INVENTION

The present invention relates to a detection device for a brushless AC/DC electric motor which detects, controls, and feeds back abnormalities, rotation speed, rotation angle, displacement, overloading and operating data of the electric motor quickly to protect the brushless AC/DC electric motor.

### BACKGROUND OF THE INVENTION

A conventional brushless magnet rotor is disclosed in U.S. Pat. No. 4,912,378, wherein a Hall element is fixed in a driver of a motor so that the driver detects a position of a rotor, but it cannot runs at high temperature or high vibration. In addition, the driver occupies large space of the motor.

TW Patent No. 1225158 disclosed a detection probe for detecting a motor, wherein the detection probe contacts with electrodes of the motor to conduct electric currents, thus judging operation of the motor. Nevertheless, such detection is troublesome.

The present invention has arisen to mitigate and/or obviate the afore-described disadvantages.

### SUMMARY OF THE INVENTION

The primary objective of the present invention is to provide a detection device for a brushless AC/DC electric motor which detects, controls, and feeds back abnormalities, rotation speed, rotation angle, displacement, overloading and operating data of the electric motor quickly to protect the brushless AC/DC electric motor.

To obtain the above objective, a detection device for a brushless AC/DC electric motor provided by the present invention contains: an input end and an output end; and the detection device also contains a signal capturing unit, a signal amplifier, a signal filter, a signal comparator, and a phase-locked loop unit which are electrically connected between the input end and the output end.

The input end is electrically connected with the power wire of the electric motor, ripples are sent from the input end and are captured by the signal capturing unit via the power wire of the electric motor and then the ripples are amplified by the signal amplifier and are filtered by the signal filter, thereafter the ripples are compared by the signal comparator and are converted into an output signal by the phase-locked loop unit.

The ripples are a voltage change and instability of AC/DC signals which are outputted.

The phase-locked loop contains phase/frequency detector (PFD), charge pump (CP), loop filter (LF), voltage controlled oscillator (VCO), and frequency divider (FD), wherein detected phase/frequency value is converted into voltage signal, filtered high-frequency generates oscillation frequency which will be fed back to compare with reference frequency. In a locked state of the electric motor, an input frequency is identical to an output frequency.

### BRIEF DESCRIPTION OF THE DRAWINGS

FIG. 1 is a schematic view of a detection device for a brushless AC/DC electric motor according to a preferred embodiment of the present invention.

### DETAILED DESCRIPTION OF THE PREFERRED EMBODIMENTS

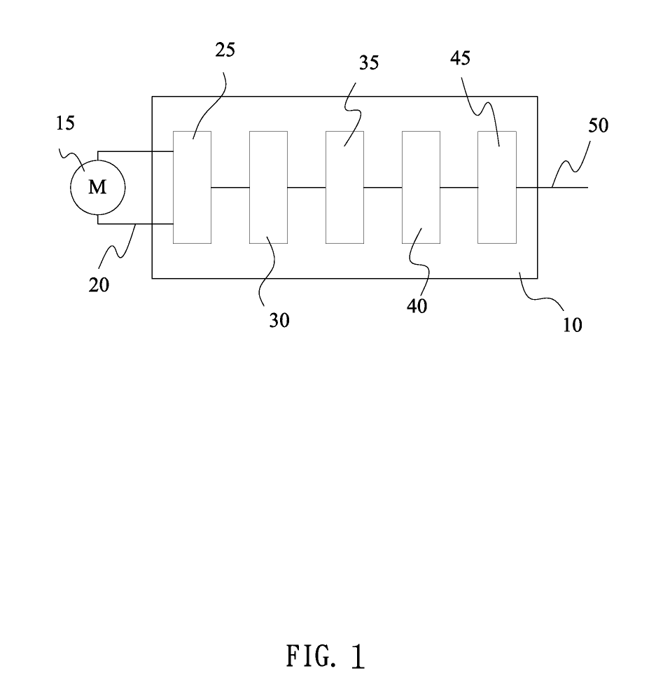

Referring to FIG. 1, a detection device 10 for a brushless AC/DC electric motor 15 according to a preferred embodiment of the present invention is employed to detect signals of the electric motor 15 and is electrically connected with the electric motor 15, wherein the electric motor 15 includes a power wire and a carbon brush and is driven by an AC/DC power source.

The detection device 10 comprises an input end 20 and an output end 50, and the detection device 10 also comprises a signal capturing unit 25, a signal amplifier 30, a signal filter 35, a signal comparator 40, and a phase-locked loop unit 45 which are electrically connected between the input end 20 and the output end 50.

The input end 20 is electrically connected with the power wire of the electric motor 15, ripples are sent from the input end 20 and are captured by the signal capturing unit 25 via the power wire of the electric motor 15, and then the ripples are amplified by the signal amplifier 30 and are filtered by the signal filter 35, thereafter the ripples are compared by the signal comparator 40 and are converted into an output signal by the phase-locked loop unit 45, such that abnormalities, rotation speed, rotation angle, displacement, overloading and operating data of the electric motor 15 are detected, controlled, and fed back, thus protecting the electric motor 15.

The ripples are a voltage change and instability of AC/DC signals which are outputted.

The phase-locked loop contains phase/frequency detector (PFD), charge pump (CP), loop filter (LF), voltage controlled oscillator (VCO), and frequency divider (FD), wherein detected phase/frequency value is converted into voltage signal, filtered high-frequency generates oscillation frequency which will be fed back to compare with reference frequency. In a locked state of the electric motor 15, an input frequency is identical to an output frequency.

Thereby, the detection device of the present invention is simplified and has a small size.

Preferably, the detection device judges the rotation speed or rotation times of the electric motor easily and quickly.

Furthermore, the abnormalities, the rotation speed, the rotation angle, the displacement, the overloading and the operating data of the electric motor 15 are detected, controlled, and fed back by the detection device.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A detection device for a brushless AC/DC electric motor being employed to detect signals and being electrically connected with the brushless AC/DC electric motor, wherein the brushless AC/DC electric motor includes a powerwire and a carbon brush and is driven by an AC/DC power source;
the detection device comprises an input end and an output end, and the detection device also comprises a signal capturing unit, a signal amplifier, a signal filter, a signal comparator, and a phase-locked loop unit which are electrically connected between the input end and the output end;
wherein the input end is electrically connected with the power wire of the electric motor, ripples are sent from the input end and are captured by the signal capturing unit via the power wire of the electric motor, and then the ripples are amplified by the signal amplifier and are filtered by the signal filter, thereafter the ripples are compared by the signal comparator and are converted into an output signal by the phase-locked loop unit.
